(19) United States
(12) Patent Application Publication
(10) Pub. No.: US 2009/0125412 A1
(43) Pub. Date: May 14, 2009

(54) TOKEN TRADING

(75) Inventors: Geoffrey Phillip Watson, New South Wales (AU); Karen Melinda Horne, New South Wales (AU); Foster Langbein, New South Wales (AU)

Correspondence Address: SNELL & WILMER LLP (OC), 600 ANTON BOULEVARD, SUITE 1400, COSTA MESA, CA, 92626, US

(73) Assignee: Flying Bark Interactive PTY Limited, Campertown, NSW (AU)

(21) Appl. No.: 12/089,833

(22) PCT Filed: Oct. 5, 2006
(86) PCT No.: PCT/AU2006/001464

§ 371 Date: Sep. 11, 2008

(30) Foreign Application Priority Data
Oct. 13, 2005 (AU) 2005905643

(51) Int. Cl. G06Q 30/00

(52) U.S. Cl. 705/26

(57) ABSTRACT

The invention concerns trading tokens, such as but not limited to, the trading of virtual trading cards. The invention also concerns a computer system (104) to facilitate the trading of tokens, a set of messages exchanged in order to trade tokens, a method of trading tokens by a token owner, and a software application to be used by the token owner to trade a token. Information relating to tokens owned by the first and second user is stored in a datastore. Using their mobile device (100), a first user (102) offers to trade a first token, and this offer is stored in the datastore (104). The server (104) then sends to the mobile communication device (112) of a second user (110) details of the offer. The second user (110) can reply by offering a second token in exchange for the first token, and this offer is also stored in the datastore and communicated to the first user (102). The first user (102) can accept the offer using their mobile device (102) and the datastore is automatically updated so that the ownership of the tokens following the exchange is recorded accordingly in the data store.

### TECHNICAL FIELD

The invention concerns trading tokens, such as but not limited to, the trading of virtual trading cards. The invention also concerns a computer system to facilitate the trading of tokens, a set of messages exchanged in order to trade tokens, a method of trading tokens by a token owner, and a software application to be used by the token owner to trade a token.

### BACKGROUND ART

Trading cards are usually sold in small packets from retail outlets such as news agencies. Cards contained in the packet are randomly selected when packed. A certain number of unique cards create a set of cards and the aim is to collect one of each card. Trading cards are a good marketing tool, especially when marketing to children. The cards are usually heavily branded, with, for example, different characters from a cartoon series or players from a football team.

### SUMMARY OF THE INVENTION

In a first aspect the invention provides a method of trading tokens between a first and second user wherein information relating to tokens owned by the first and second user is stored in a datastore, the method comprising the steps of:

receiving from a first mobile communication device of a first user a first offer to trade a first token owned by the first user, and storing the first offer in the datastore;

sending to a second mobile communication device of a second user details of the first offer;

receiving from the second mobile communication device of the second user a second offer to trade with the first user a second token owned by the second user in exchange for the first token, and storing the second offer in the datastore;

sending to the first mobile communication device of the first user details of the second offer;

receiving an acceptance of the second offer from the first mobile communication device of the first user;

automatically updating the stored information relating to tokens owned by the first user in the datastore by removing the first token and adding the second token; and

automatically updating the stored information relating to tokens owned by the second user in the datastore by removing the second token and adding the first token.

Using the invention, a user can collect tokens on their mobile telecommunications device. They also have the convenience of being able to trade these tokens using their mobile telecommunications device which is usually carried with the user at all times. The tokens can also be traded between users that have no prior knowledge of each other and in virtually real time. This obviates the need for the usual rating system common in online auction sites that track the honesty or good faith of the trader. Using the invention, a user is able to trade tokens without the intermediate step of converting the traded item to a notional monetary value.

By storing the information on tokens owned by the first or second user in a datastore, rather than on the first and second mobile communication device, the first and second user are able to view their tokens from a variety of client devices that are able to retrieve information on the datastore. In this way the first user would be able to see the same set of tokens from their first mobile communication device and say their personal computer. Further, a common datastore storing information on tokens owned by all users reduces the ability to cheat by gaining further tokens that the user is not entitled to.

The step of sending the second mobile communication device details of the first offer may be performed upon receiving a request from the second user.

The step of sending to the first mobile communications device of the first user the details of the second offer may be performed automatically once the second offer is received.

An offer may be comprised of details of the token that is offered for trade and optionally a text based message.

The mobile communication device can include a mobile phone or a Personal Digital Assistant (PDA).

The tokens may provide on the first communication device an image for display, sound for playing, a video for playing or any other media for output. The tokens may be virtual trading cards. Tokens may be themed. A combination of unique tokens may comprise a set.

The method may further comprise receiving from a first mobile communication device of a first user a request to purchase a token, processing the request by updating the information on tokens owned by the first user in the datastore by adding the purchased token.

The method may further comprise receiving a login request from the first mobile communication device of the first user. The datastore may also store login verification information of the first user. The datastore may be a transactional database.

The method may be performed by a server that is able to receive messages from mobile communication devices. The datastore may be contained within the server. The server may be connected with the Internet and may host a website. The method may comprise receiving messages from the website from the first or second user. The datastore may be a transactional database.

The datastore that stores the offers made may be separate to the datastore that stores the information on tokens owned by the first user and the second user.

When a message is sent or received from the first mobile communication device, the method may further comprise debiting the first user through their account with the mobile service provider of the first user.

In a further aspect the invention provides a computer system to facilitate the trading of tokens between a first mobile communications device of a first user and a second mobile communications device of a second user, the computer system comprising:

a communications port to receive from a first mobile communication device of a first user a first offer to trade a first token; to send to a second mobile communication device of a second user details of the first offer; to receive from the second mobile communication device of the second user a second offer to trade with the first user a second token in exchange for the first token; to send to the first mobile communication device of the first user details of the second offer; and to receive an acceptance of the second offer from the first mobile communication device of the first user;

a datastore to store information relating to tokens owned by the first and second users, and details of the first and second offer; and

a processor to determine when to send the details of the first offer to the second mobile communication device and details of the second offer to the first mobile communication device, to automatically update the stored information relating to tokens owned by the first user in the datastore by removing the first token and adding the second token; and to automatically update the stored information relating to tokens owned by the second user in the datastore by removing the second token and adding the first token.

In yet a further aspect the invention provides a set of messages exchanged to trade tokens by a first user with a second user using their mobile communication devices and communicating through a server, the message set comprising:

a first offer message sent to a server from a first mobile communication device of the first user that includes information on a first offer to trade a first token;

a first offer relay message sent from the sever to a second mobile communication device of the second user that includes information on the first offer to trade a first token;

a second offer message sent to the sever from the second mobile communication device of the second user that includes information on the second offer to trade with the first user a second token in exchange for the first token;

a second offer relay message sent from the server to the first mobile communication device of the first user that includes information on the second offer;

an acceptance message sent to the server from the first mobile communication device of the first user accepting the second offer; and

a confirmation message sent from the server to the first mobile communication device of the first user and to the second mobile communication device of the second user confirming that the trade has taken place.

In yet a further aspect the invention provides a method of trading tokens owned by a first user with tokens owned by a second user and communicating through a third party server, the method comprising the steps of:

logging into the server using a mobile communication device;

sending to the server a first offer to trade a first token from the mobile communication device;

receiving on the mobile communication device a second offer sent from the server, the offer being to trade the first token with a second token of a second user;

sending to the server an acceptance to the second offer from the first mobile communication device of the first user; and

receiving on the mobile communication device a confirmation message sent from the server confirming that the trade has taken place.

In an even further aspect the invention provides a software application that is installed on a first mobile communication device to enable it to perform the method described above.

### BRIEF DESCRIPTION OF THE DRAWINGS

An example of the invention will now be described with reference to the accompanying drawings in which:

FIG. 1 is a schematic view of the system of the current invention;

FIGS. 2 to 26 are various screen shots of displays on a mobile communication device that is able to trade tokens in accordance with the current invention;

FIG. 27 is a simplified flowchart showing the various features of the current invention;

FIG. 28 is a simplified flowchart showing the method of offering a token for trade online using the current invention;

FIG. 29 is a simplified flowchart showing the method of responding to an offer of trade using the current invention; and

FIG. 30 is a sample interface to the server.

### BEST MODES OF THE INVENTION

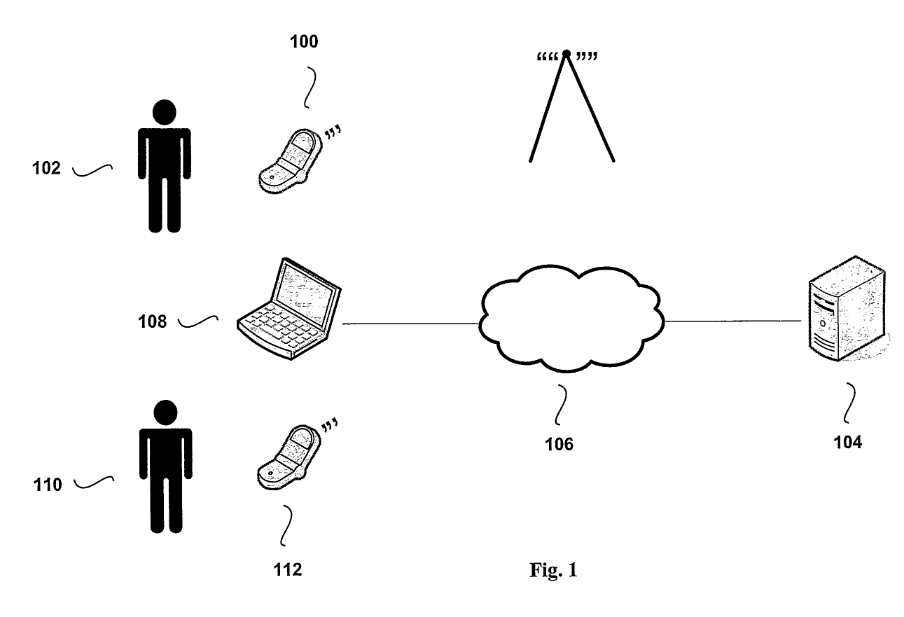

The computer system of the current invention will be described with reference to FIG. 1. A software application is installed on a mobile communications device 100 of the user 102. The mobile communication device 100 can be any mobile communication device that can receive and install a software application, such as many of today's mobile phones or Personal Digital Assistants (PDAs). The software application is a J2ME application. The software enables the user 102 to use their mobile communication device to interact with the transactional data base (discussed below).

The computer system also comprises a server 104. The server 104 includes a datastore that stores the server software application. The datastore also includes a database that stores:

the details of all users registered with the system, including their login name and password;

information on any tokens owned by the user, including the number and details of all tokens owned by each user;

the details of any offers for trade that the user has made and a list of all current responses;

the credit the user has;

any messages from the system such as user's status, token purchase, or trade completion; and

properties of each collectible token e.g. card images, properties, descriptions.

The data store is a transactional database that has the ability to handle transactions involving the tokens (as discussed in more detail below). By storing the details of tokens owned by each user in a common datastore, each user is able to access and view their tokens from a variety of devices and still see the same set of tokens. Further, the server 104 is operated, directly or indirectly, by a third party. In this way each user is prevented from cheating by gaining cards which they are not entitled to. For example, if the details of tokens owned by a user 102 were stored on their mobile communication device 100 then if a cookie was stored on this mobile communication device 100 this opens up the possibility that the user 102 could copy their phone data, make a trade and then restore their previous data thus gaining cards which they are not entitled to.

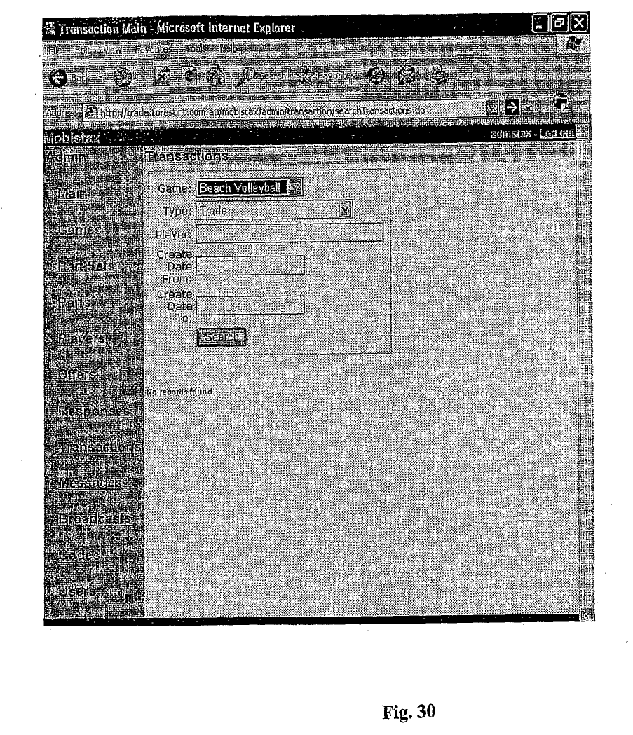

Access to the server 104 may be provided using an administration interface as shown in FIG. 30 which operates as an interface to the underlying database. Using the interface the third party is able to mange the entire trading system. For example, the third party is able to load into the database a new game having new cards, card probabilities of being bought, card files and currency. Using the interface a new card can be added to an existing game and change the running status of the existing game should a game need to be paused for maintenance. Further, the third party is able to communicate with players and update their details, delete arbitrary offers, responses and messages, and broadcast messages to all current players in the game. Third party is able to check for all completed trades by looking at transaction logs stored in the database.

The server 104 and mobile communication device 102 have one or more communication means that allows them to communicate. The communication protocol is defined by the software application. If a selection or action that is made by the user 102 (or 110) requires information from the database stored on the server 104 to be retrieved, a message is sent from the mobile communication device 100 (or 112) to the server 104 using a protocol defined by the software application, such as over an http or https connection. The requested information is then sent to the mobile communication device 100 (or 112) using the same messaging protocol. The software application is able to interpret the message and display the requested information as required.

Every user 102 interaction with the database of the server 104 is encapsulated as a single transaction, so that any errors or failures that occur can be rolled back.

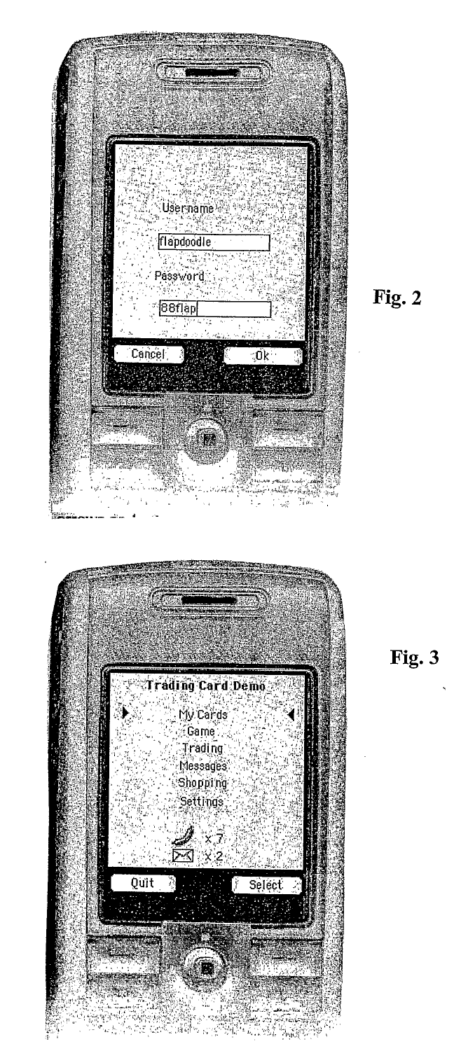

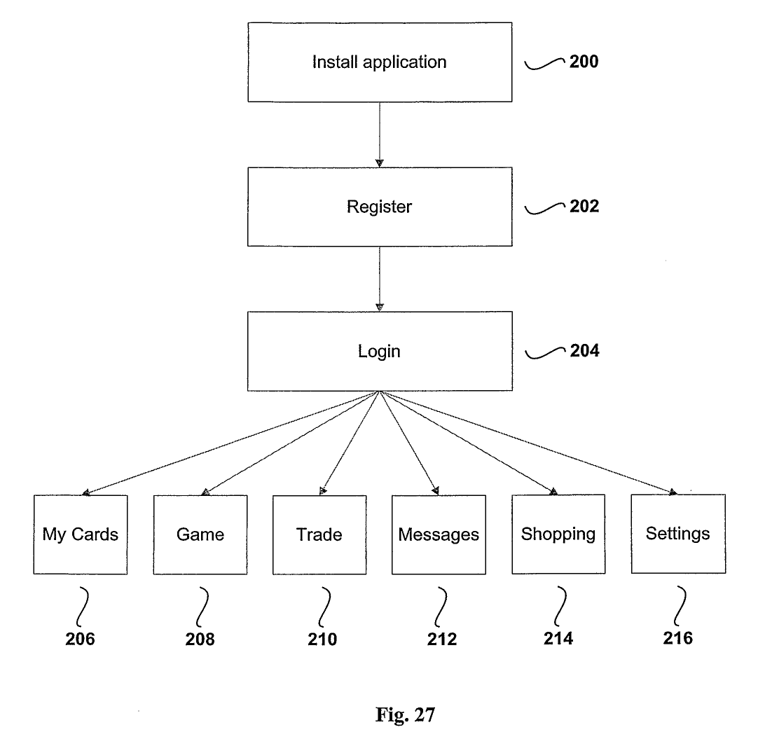

A method of using the invention will now be described in reference to the flowchart of FIG. 27 and the screens of FIG. 2 to FIG. 26. In this example the tokens are virtual trading cards. In practice, these virtual trading cards would be heavily branded, such as with cartoon characters or players from a football team. The tokens may not all be of the same media type. For example, one or more tokens may be comprised of any media that can be stored on the mobile communication device 100. For example, text, a small video clip, a sound file or image file. A token may be one of a set of tokens, such as a virtual card that is part of a deck. The image token may form a whole picture with the rest of the image tokens from the set. In the same way, the video token may form part of a longer video clip. The text token may form part of a story.

Initially, the user 102 will install 200 the software application onto the mobile communication device 100. To do this the user 102 may download and install the software application over the air (OTA) from the Internet 106 onto their mobile communication device 100 using a dedicated website. Alternatively, the user may download the software application onto the mobile communication device 100 by downloading it directly from their service provider. In that case the service provider would also have a stored copy of the software application. It may be possible for the user 102 to download the software application to their personal computer 108 and then install it on their mobile communication device 100 by connecting it to their personal computer 108.

The user 102 must also register 202 with the server 104. This may be achieved through the dedicated website or through a series of screens now available on the mobile communication device 100 using the software application. The registration details of the user 102, which include a user name and password, is then stored on the server 104. The registration process will also define how the user 102 pays for the service, such as a monthly fee or fee proportional to the number of accesses to the server 104 that is debited from their mobile phone bill.

Using the mobile communication device 100 the user 102 may then login 204 to the system as shown in FIG. 2 by entering their username and password. The username in this case is “flapdoodle” and the password is “88flap”. The user name and password is then sent to the server 104 in a predefined message format. The server 104 receives the message and verifies the login details by comparison with those stored on the database. If the server 104 verifies that the login name and password are correct a menu system is then displayed on the mobile communication device 100 as shown in FIG. 3. The user's session is maintained using a session cookie.

From this menu screen various functions can be performed by the user 102. The user 102 may select to:

access their cards 206

play a game with their cards 208

trade their cards 210

view their messages 212

purchase more cards 214

adjust their user settings 216

From the screen shown in FIG. 3 the user 102 can also see the credit they have. In this case the currency is sausages and the user can see that they have two sausages. The value of a sausage in relation to the tokens is predefined. The user 102 can also see the number of messages that they have, in this case the messages are indicated by an envelope and the user 102 has two messages.

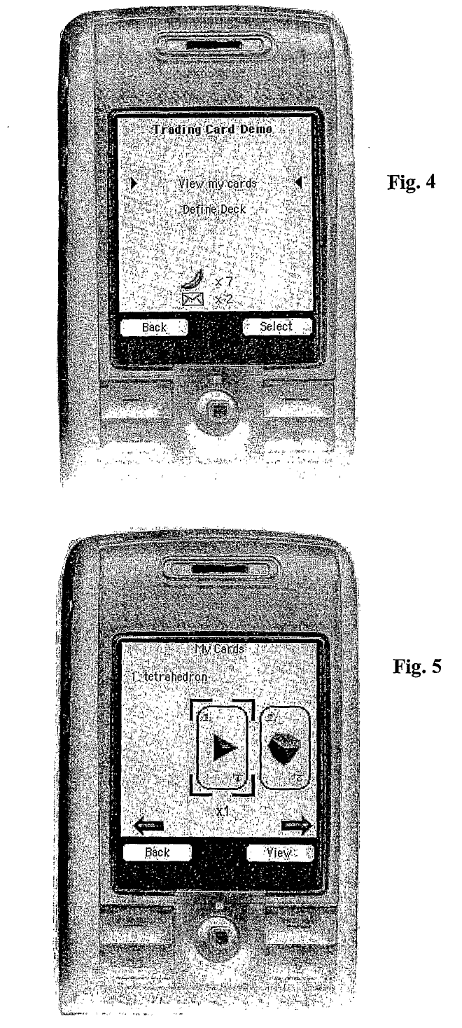

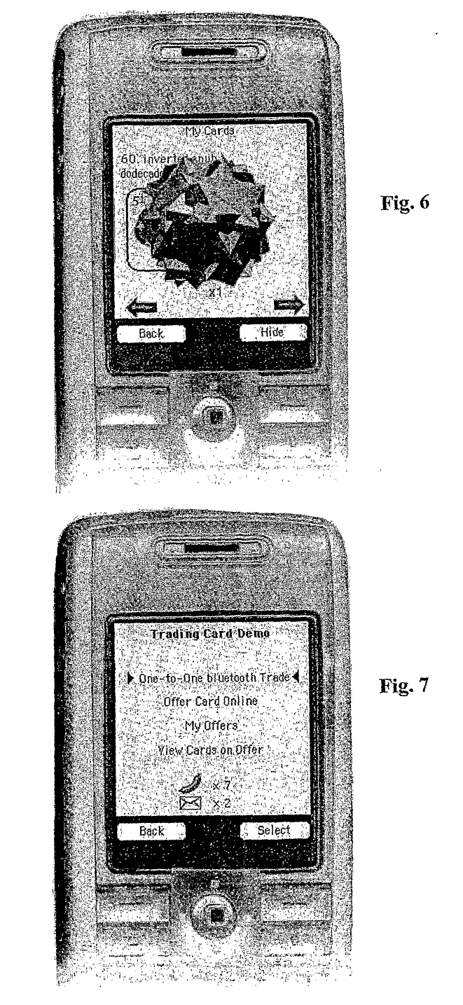

From this menu screen, the user 102 may select to access 206 their cards. This selection causes the screen shown in FIG. 4 to be displayed which allows the user 102 to choose from either viewing their cards or to define their deck. If the user 102 selects to view their cards a screen such as that shown in FIG. 5 is then displayed to the user 102 on the mobile communication device 100. The user 102 may then scroll through the cards and underneath each card an indication is made as to the number of cards of that type that the user 102 has. In this case the user 102 has one of the Tetrahedron cards. A user 102 may also select a card as shown in FIG. 6 to see more details about the card, such as a more detailed description and an enlarged view. In this example the cards are comprised of multisided shapes. Referring to FIG. 4, if the user 102 selects to define their deck, the user 102 is able to select a subset of the user's 102 cards to use in the game section.

Referring back to FIG. 3 the user 102 may also play games with their cards. These games may be single player games adapted to interact with the cards, or may involve communication to a server 104 or with a second user 110. The second user 110 also has their own mobile communication device 112 and the game may be played using communication means between the two devices such as SMS messaging or Bluetooth. Games may result in cards being won or lost, or currency (which in this case is sausages) to be won or lost. The server 104 would be notified of this change and appropriate changes would then be made to the user's 102 and 110 information stored in the database.

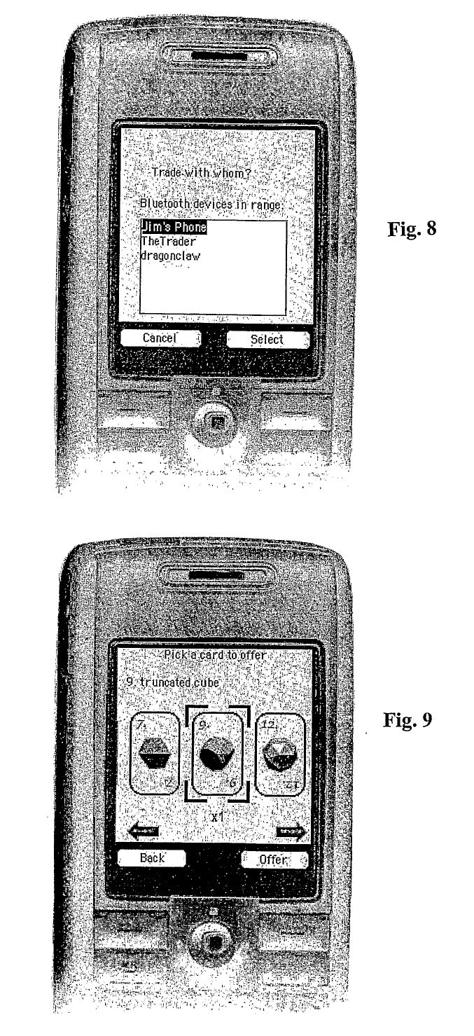

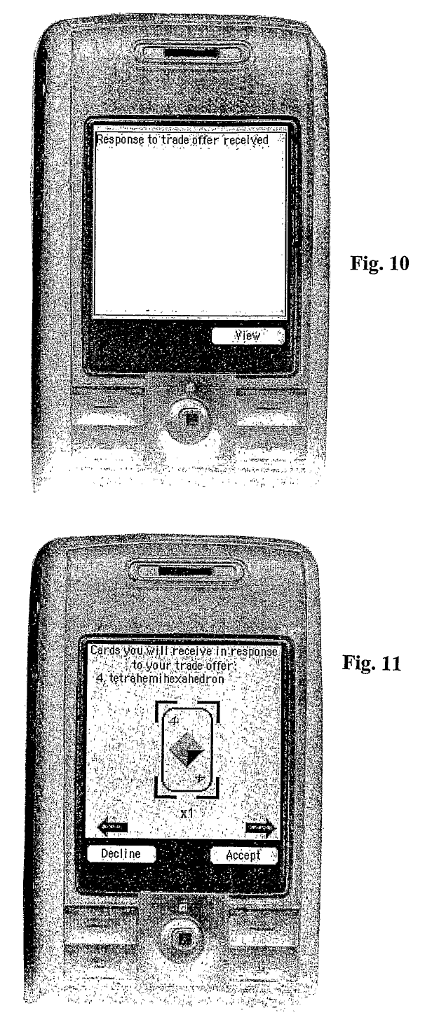

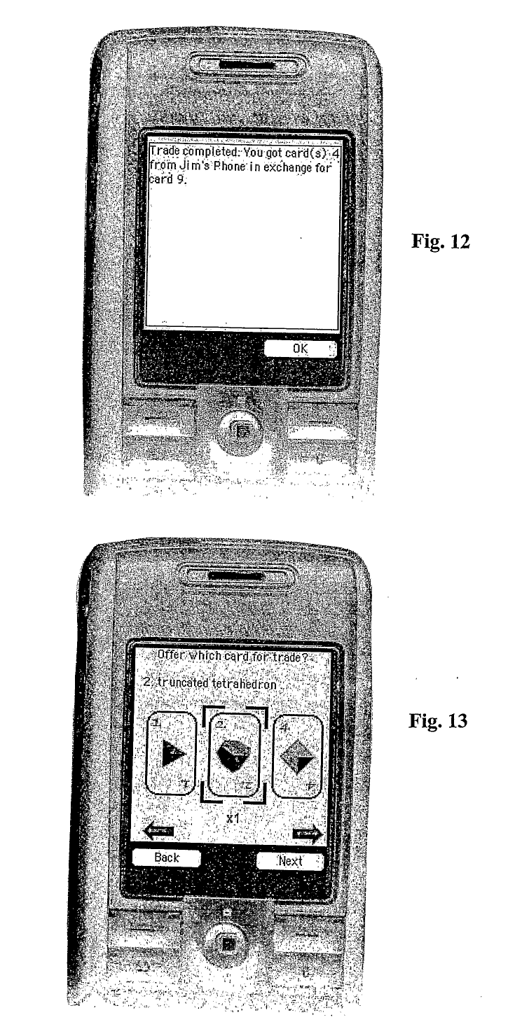

Referring back to the menu of FIG. 3 the user 102 may also choose to trade 210 their cards. As shown on FIG. 7 there are multiple ways to trade their cards. The first method is one to one Bluetooth trade. That is, using Bluetooth technology the user 102 may trade directly with another user 110 using their respective mobile communication devices 100 and 112. The user's 102 mobile communication device 100 detects the presence of various Bluetooth compatible appliances as shown in FIG. 8. In this case Jim's phone is the mobile communication device 112 that the user 102 wishes to do trade with. The user 102 selects Jim's phone as shown in FIG. 8. The user 102 then selects which card they wish to offer to user 110. This is done by scrolling as shown in FIG. 9. In this case the user offers card number nine. The offer is then directly communicated via Bluetooth from the mobile communication device 100 to mobile communication device 112. The user 110 may accept the offer in which case the user 102 receives on their mobile communication device 100 a response to the offer as shown on FIG. 10. Further details of the response can be viewed as shown in FIG. 11, in this case the user 102 is able to see that user 110 has offered card four in exchange for card nine. The user 102 may then choose to accept or decline the trade offer. If the user 102 declines the offer a message of decline is then sent to user 110 via mobile communication devices 100 and 112. If the user 102 accepts the offer a message is sent from user 102 to user 110 accepting the offer via mobile communication devices 100 and 112. Mobile communication device 100 then displays the screen shown in FIG. 12 which shows a summary of the exchange. A message is then sent automatically to the server 104 by one or both of mobile communication devices 100 or 112 containing information of the trade.

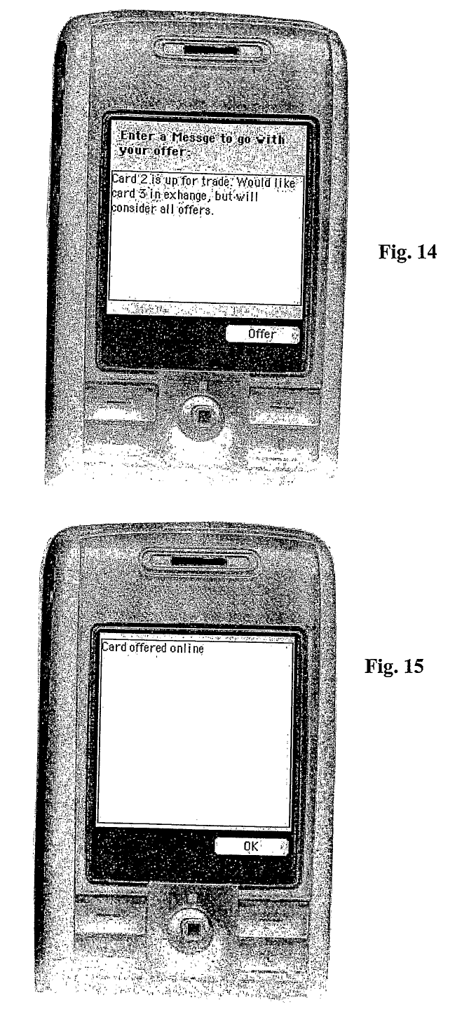

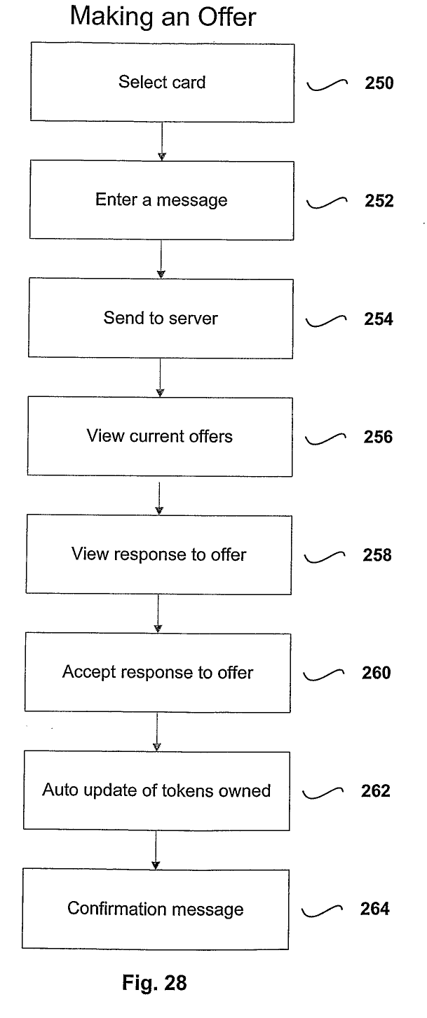

Referring back to FIG. 7, after some time has passed the user 102 may choose to offer a card online. The method of trading a card online will be described with reference to FIG. 28. As shown in FIG. 13, the user 102 must first compile the contents of the offer by selecting a card to trade 250. In this case the user 102 has selected card number two Truncated Tetrahedron. As shown in FIG. 14 the user 102 is also prompted to enter a message 252 to accompany the trade. In this case the user 102 has entered the text “Card 2 is up for trade. Would like card 3 in exchange but will consider all offers”. The trade offer is then communicated 254 to the server 104 by pressing the offer button causing a message containing the details of the trade to be sent to the server 104. Once the server 104 receives this message, details about the offer are stored on the database. A confirmation message that the server 104 successfully received the offer for trade from user 102 is sent back to the user 102 and a confirmation message is displayed on the mobile communication device 100 as shown in FIG. 15.

Referring back to FIG. 7 the user 102 may also choose to view 256 all of their offers currently placed online, that is, offers previously made by them and stored on the database. Once the user 102 selects to view their offers a message is sent to the server 104 from mobile communication device 100. A reply message is then sent from the server 104 to the mobile communication device 100 containing details of the user's 102 offers and any replies to the offers that the server 104 has received from other users and have been stored in the database.

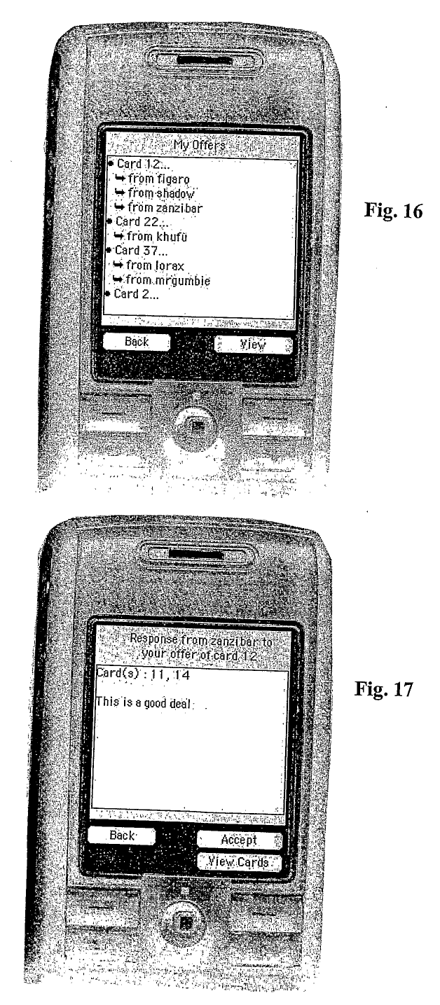

In this instance the user 102 has made multiple offers and this is shown on the summary screen of FIG. 16. Each offer has had a response from other users. In this case card twelve has been offered online by user 102 and a further user (such as user 110) has made a response. Details of the user “Zanzibar's” response to user's 102 offer of card twelve can be viewed 258 by selecting Zanzibar's offer and this is shown in FIG. 17. In this case user Zanzibar has offered cards eleven and fourteen in return.

The user 102 may accept 260 the offer. In this case user 102 accepts the response offer by pressing the accept option as shown in FIG. 17. A message indicating the user 102 has accepted Zanzibar's response is sent to the server 104 from the device 100.

The server 104 then automatically updates 262 the database to reflect that trade. In this case card twelve is removed from user's 102 ownership and cards eleven and fourteen are added in replacement. To Zanzibar's ownership of cards, card twelve is added and cards eleven and fourteen are removed.

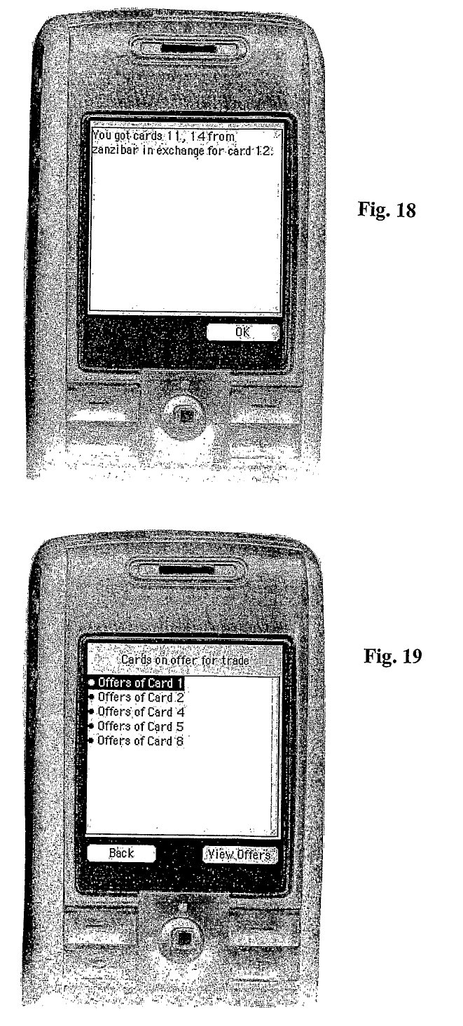

The server 104 then sends a confirmation message 264 back to the user 102 as shown in FIG. 18. A confirmation message is also sent to Zanzibar 110. That message would indicate that the user 110 has now traded cards eleven and fourteen in exchange for card twelve.

In accordance with the method, the direct trading of collectable cards can be made without the intermediate step of converting the card to a notional monetary value. In this trading system there is no “highest bidder”. As a result the system must track and display all responses to an offer. Other users may in some sense “better” a given offer by offering more or better cards in response but it is up to the user making the initial offer which of the responses is the winning one. In trading or swapping of collectibles the personal value of a given collectable is dependent on the user's current collection (e.g. user 102 may value Zanzibar's offer of cards eleven and fourteen as user 102 needs one of these cards in order to complete the card set) or even personal preference of the user (e.g. user 102 prefers Zanzibar's offer as card fourteen includes a favourite graphic of the user 102). There may be no time limit to a trade offer. In practice however, a time limit may be applied to keep the list of trade offers and responses manageable and to keep the database running optimally.

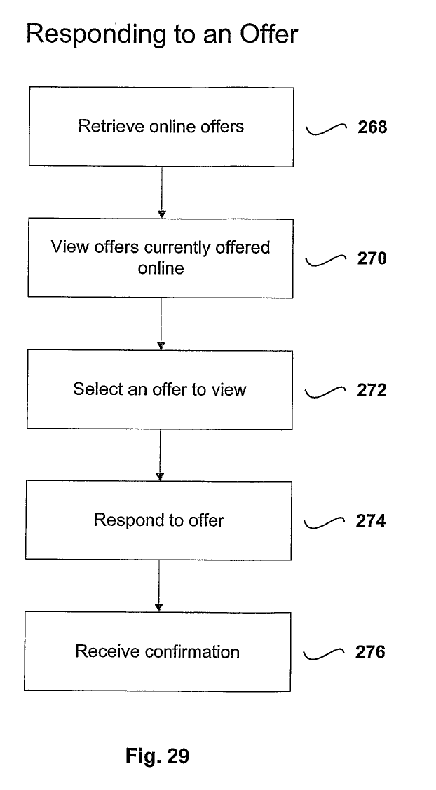

Referring back to FIG. 7 the actions of the user 110 to respond to user's 102 offer will be explained with reference to the flowchart of FIG. 29. In this case the user 110 wishes to view trades currently offered online 270. The user 110 sends a message to the server 104 and retrieves 268 from the database details of all offers made by other users.

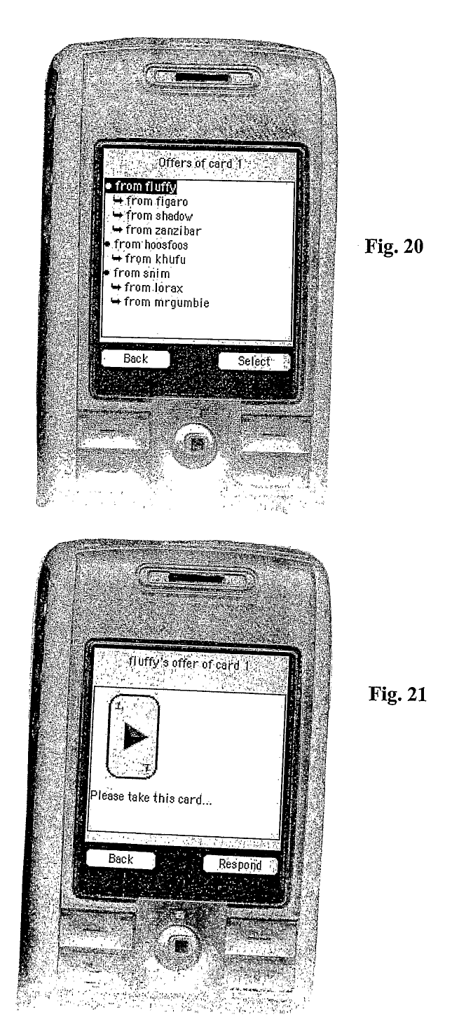

A summary of these offers is then displayed on the screen as shown in FIG. 19 following receipt of the information from the server 104. User 110 can see that five cards are on offer. The user 110 now selects an offer to 272 view the details of and selects the offer of card one. Details of the offers that include card eleven are retrieved from the server 104 and displayed to the user 110 as shown on FIG. 20. Here three users, Fluffy, Hoosfoos and Snim, have made offers that include card one.

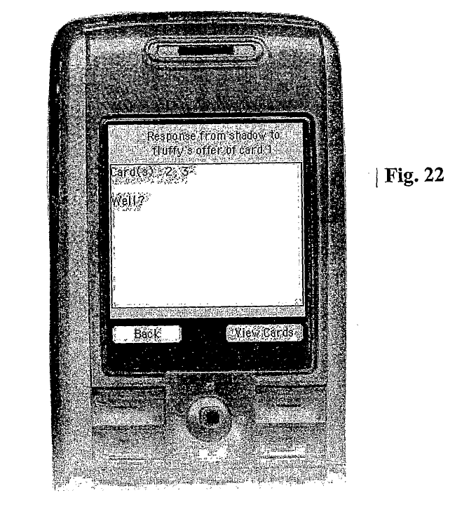

The user 110 selects the offer made by Fluffy to see further details as shown in FIG. 21. The user can also select one of the three response offers already made to Fluffy's offer of card eleven. In this case, user 110 selects to see the details of Shadow's response offer. This is retrieved from server 104 and displayed as shown in FIG. 22.

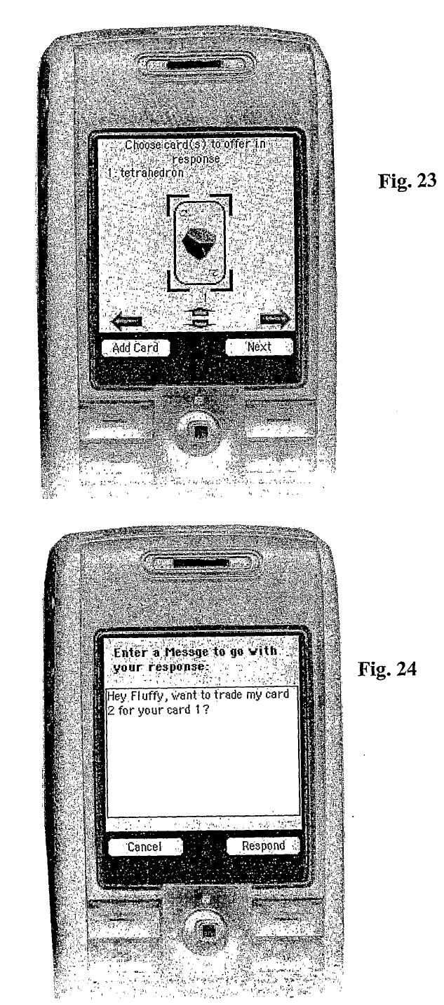

User 110 now knows what other offers exist and this will affect which cards 110 offers. From the screen shown at FIG. 21, user 110 selects to respond 274 to Fluffy's offer by composing a reply message. This includes writing a message as shown in FIG. 24 and selecting one or more cards to offer in return as shown in FIG. 23

As described above, user 102 retrieves user's 110 response offer and accepts it. User 110 now receives a confirmation message 276 and their ownership information is amended in the database as described above.

Even though a trade is not complete, any card included in user's 102 offer can be included in a second offer. If this second offer is accepted, the server will automatically delete any other offers that include a card that was in the second offer.

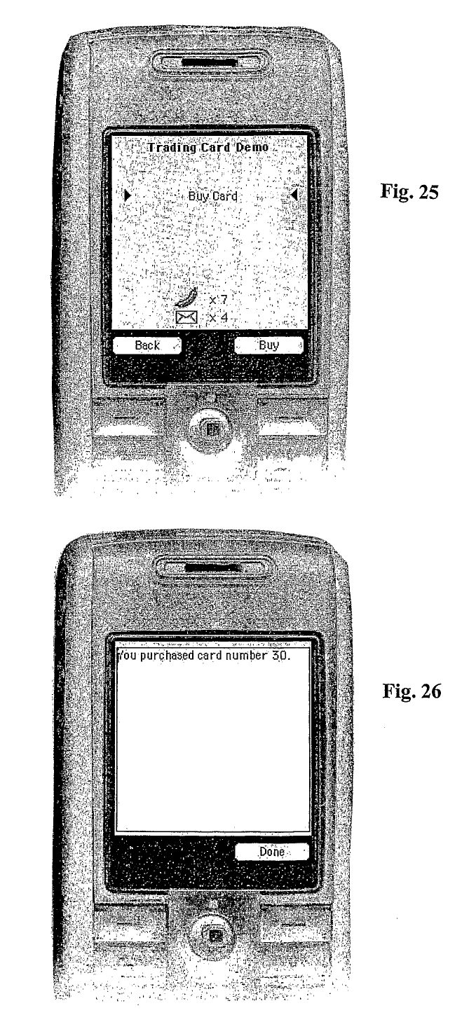

Referring back to FIG. 3 the user may also go shopping 214. As shown in FIG. 25, in exchange for a number of sausages the user 102 may buy a card. A message is sent to the server requesting a purchase of a card. Like real world trading cards, the purchase is random. The user 102 receives a message from the server 104 advising which card they have purchased. The server 104 checks that the user 102 has sufficient credit for the purchase. FIG. 26 shows the confirmation message that card thirty was purchased. The server automatically operates to update user's 102 ownership to include the new card thirty and to deduct the predefined number of sausages from their credit.

As shown on FIG. 7 the user 102 may also change the settings 216 of the software application installed on their mobile communication device 100, such as their login details and automatically sending requests to the server 104 at regular intervals to see if a response to an offer previously made online by the user 102 is available and then notifying the user 102 by the playing of a sound.

It will be appreciated by persons skilled in the art that numerous variations and/or modifications may be made to the invention as shown in the specific embodiments without departing from the spirit or scope of the invention as broadly described.

For example, the server 104 may be separated and placed in different locations. One server may host the website. Another server may be responsible for receiving and sending messages and updating the database. The database may not be contained within the server 104, but located remotely.

Further, an offer may include one or more tokens.

The application software can be easily extended within the scope of the invention to offer further functions, such as a displaying on the mobile communication device to the user the “available quantity” describing how many tokens may be placed into each offer. A user may send a message to any other registered user. The interfaces presented to the user on the mobile communication device regarding offers and responses may be consolidated into the one interface.

The present embodiments are, therefore, to be considered in all respects as illustrative and not restrictive.

1. A method of trading tokens between a first and second user wherein information relating to tokens owned by the first and second user is stored in a datastore, the method comprising the steps of:
receiving from a first mobile communication device of a first user a first offer to trade a first token owned by the first user, and storing the first offer in the datastore;
receiving from the second mobile communication device of the second user a second offer to trade with the first user a second token owned by the second user in exchange for the first token, and storing the second offer in the datastore;
sending to the first mobile communication device of the first user details of the second offer;
receiving an acceptance of the second offer from the first mobile communication device of the first user;
automatically updating the stored information relating to tokens owned by the first user in the datastore by removing the first token and adding the second token; and
automatically updating the stored information relating to tokens owned by the second user in the datastore by removing the second token and adding the first token.

2. A method according to claim 1, wherein the step of sending the second mobile communication device details of the first offer is performed automatically upon receiving a request from the second user.

3. A method according to claim 1 wherein the step of sending to the first mobile communications device of the first user the details of the second offer is performed automatically once the second offer is received.

4. A method according to claim 1, wherein details of an offer includes information on the token that is offered for trade.

5. A method according to claim 1, wherein the mobile communication device can include a mobile phone or a Personal Digital Assistant (PDA).

6. A method according to claim 1, wherein the token is data that is stored on the first communication device that represents an image, sound, text or video.

7. A method according to claim 1, wherein the tokens are virtual trading cards, and a combination of unique tokens comprises a set.

8. A method according to claim 1, wherein the method further comprises receiving from a first mobile communication device of a first user a request to purchase a token, and processing the request by updating the information relating to tokens owned by the first user in the datastore by adding the purchased token.

9. A method according to claim 1, wherein the datastore stores login verification information of the first user, and the method further comprises receiving a login request from the first mobile communication device of the first user.

10. A method according to claim 1, wherein the method is performed by a server that is able to receive messages from mobile communication devices and the datastore is a transactional database that is associated with the server.

11. A method according to claim 1, wherein when a message is sent or received from the first mobile communication device, the method further comprises debiting the first user through the account which the first user holds with a mobile service provider.

12. A computer system to facilitate the trading of tokens between a first mobile communications device of a first user and a second mobile communications device of a second user, the computer system comprising:
a communications port to receive from a first mobile communication device of a first user a first offer to trade a first token; to send to a second mobile communication device of a second user details of the first offer; to receive from the second mobile communication device of the second user a second offer to trade with the first user a second token in exchange for the first token; to send to the first mobile communication device of the first user details of the second offer; and to receive an acceptance of the second offer from the first mobile communication device of the first user;
a datastore to store information relating to tokens owned by the first and second user, and details of the first and second offer; and
a processor to determine when to send the details of the first offer to the second mobile communication device and details of the second offer to the first mobile communication device, to automatically update the stored information relating to tokens owned by the first user in the datastore by removing the first token and adding the second token; and to automatically update the stored information relating to tokens owned by the second user in the datastore by removing the second token and adding the first token.

13. A computer system according to claim 12, wherein the computer system has multiple communication ports to send and receive offers and acceptances of trades.

14. A computer system according to claim 12, wherein the communication ports may be enabled to send or receive messages using http or https protocol.

15. A computer system according to claim 12, wherein the mobile communication device is a mobile phone or a Personal Digital Assistant (PDA).

16. A computer system according to claim 12, wherein the computer system further provides a display device to display a user interface to the datastore.

17. A computer system according to claim 12, wherein the communication port receives from the second mobile communication device of the second user a request to receive the first offer, and the processor causes the communication port to send details of the first offer to the second mobile communication device.

18. A computer system according to claim 12, wherein the processor causes the communication port to automatically send to the first mobile communication device of the first user the details of the second offer once the second offer is received.

19. A computer system according to claim 12, wherein details of an offer includes information on the token that is offered for trade.

20. A computer system according to claim 12, wherein the communication port receives from the first mobile communication device of the first user a request to purchase a token, and the processor operates to update the information relating to tokens owned by the first user in the datastore by adding the purchased token.

21. A computer system according to claim 12, wherein the datastore stores login verification information of the first user, and the communication port further receives a login request from the first mobile communication device of the first user that is processed by the processor.

22. A computer system according to claim 12, wherein the datastore is a transactional database.

23. A method of trading tokens owned by a first user with tokens owned by a second user and communicating through a third party server, the method comprising the steps of:
logging into the server using a mobile communication device;
sending to the server a first offer to trade a first token from the mobile communication device;
receiving on the mobile communication device a second offer sent from the server, the offer being to trade the first token with a second token of a second user;
sending to the server an acceptance to the second offer from the first mobile communication device of the first user; and
receiving on the mobile communication device a confirmation message sent from the server confirming that the trade has taken place.

24. A method according to claim 23, wherein the method further comprises sending to the server a request to receive the offer on the first mobile communication device.

25. A method according to claim 23, wherein details of an offer includes information on the token that is offered for trade.

26. A method according to claim 23, wherein the mobile communication device is a mobile phone or a Personal Digital Assistant (PDA).

27. A method according to claim 23, wherein the token is data that is stored on the first mobile communication device that represents an image, sound, text or video.

28. A method according to claim 23, wherein the tokens are virtual trading cards, and a combination of unique tokens comprises a set.

29. A method according to claim 23, wherein the method further comprises sending to the server from a first mobile communication device of a first user a request to purchase a token.

30. A method according to claim 23, wherein the method initially comprises installing on the first mobile communication device a software application to enable the first mobile communication device to send the offer and acceptance to the server.

31. A software application that is installed on a first mobile communication device to enable it to perform the method described in claim 23.

32. A set of messages exchanged to trade tokens by a first user with a second user using their mobile communication devices and communicating through a server, the message set comprising:
a first offer message sent to a server from a first mobile communication device of the first user that includes information on a first offer to trade a first token;
a first offer relay message sent from the sever to a second mobile communication device of the second user that includes information on the first offer to trade a first token;
a second offer message sent to the sever from the second mobile communication device of the second user that includes information on the second offer to trade with the first user a second token in exchange for the first token;
a second offer relay message sent from the server to the first mobile communication device of the first user that includes information on the second offer;
an acceptance message sent to the server from the first mobile communication device of the first user accepting the second offer; and
a confirmation message sent from the server to the first mobile communication device of the first user and to the second mobile communication device of the second user confirming that the trade has taken place.
